(19) United States
(12) Patent Application Publication
(10) Pub. No.: US 2022/0290349 A1
(43) Pub. Date: Sep. 15, 2022

(54) PASSIVE SENSING FIBER COMPOSITIONS AND COMPOSITES THEREOF

(71) Applicant: UT-Battelle, LLC, Oak Ridge, TN (US)

(72) Inventors: Christopher C. Bowland, Knoxville, TN (US); Amit K. Naskar, Knoxville, TN (US); Sumit Gupta, Knoxville, TN (US)

(21) Appl. No.: 17/690,432

(22) Filed: Mar. 9, 2022

Related U.S. Application Data
(60) Provisional application No. 63/158,921, filed on Mar. 10, 2021.

(51) Int. Cl. D06B 3/02; D06B 21/00; G01N 27/20

(52) U.S. Cl. CPC D06B 3/02; D06B 21/00; G01N 27/20

(57) ABSTRACT

A composition comprising: (i) an electrically non-conductive fiber having a surface; and (ii) piezoelectric particles adhered to the surface of said electrically non-conductive fiber, and optionally, (iii) a sizing agent (e.g., epoxy) coated over the piezoelectric particles and surface of the electrically non-conductive fiber. Also described are composites in which the above fiber composition is embedded within a matrix, e.g., a polymer, ceramic, or glassy carbon matrix. Also described is a method for producing a passive sensing fiber composition by: coating a fiber having a surface with a liquid suspension containing piezoelectric particles suspended in a solvent; and removing the solvent to result in the piezoelectric particles adhered to the surface of the fiber. Also described are methods for detecting formation of defects in a material and methods of generating electrical energy from ambient vibration by use of the above described fiber compositions and composites thereof.

### CROSS-REFERENCE TO RELATED APPLICATIONS

The present application claims benefit of U.S. Provisional Application No. 63/158,921, filed Mar. 10, 2021, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to passive sensing fibers and composites containing these fibers, and more particularly, wherein the passive sensing fibers include a base fiber substrate coated with a piezoelectric material.

### BACKGROUND OF THE INVENTION

Fiber-reinforced polymer composites are widely used in several industries, including the aviation, automobile, and wind turbine industries, due to their high strength-to-weight ratio. However, they often exhibit poor interlaminar shear strength (ILSS), which leads to delamination between fibers and the polymer matrix. Additionally, these composites can undergo sudden failures with negligible surface-observable damage identifiers.

With the commercial adoption of these high-performance composites in structural applications, a need for in situ monitoring (i.e., structural health monitoring, or SHM) of their structural integrity is critical. In the case of composites containing carbon fibers, a common method for in situ monitoring is measuring through-thickness resistance changes of the fiber-matrix composite by virtue of the electrically conductive nature of the carbon fibers. This provides information on whole-body stress levels imparted on the composite and can help identify the presence of damage. However, as this technique relies on the carbon fiber and polymer matrix to reveal a resistance change, the damage detection sensitivity is insufficient for detecting earlier, more subtle precursors to failure. Methods are needed for detecting precursors to failure with much greater sensitivity. There would be a further benefit in replacing carbon fiber with a fiber material of comparable or superior mechanical properties, and preferably, with an improved ILSS when incorporated into a matrix material, while effectively detecting the onset of defects.

### SUMMARY OF THE INVENTION

In one aspect, the present disclosure is directed to a passive sensing fiber composition that provides enhanced structural health monitoring (SHM) sensitivity and increased interlaminar shear strength (ILSS) in a material in which it is incorporated. As further discussed below, the fiber composition can be produced by a straight-forward and low cost process. For the fiber to possess SHM ability, the fiber is adhered to particles possessing a piezoelectric property. In some embodiments, the fibers have at least the same or greater strain to failure, and thus, lower risk of brittle fracture, compared to carbon fiber.

In particular embodiments, the fiber composition includes precisely or at least the following components: (i) an electrically non-conductive fiber having a surface; and (ii) piezoelectric particles adhered to the surface of the electrically non-conductive fiber. In some embodiments, the fiber composition also includes: (iii) a sizing agent (e.g., epoxy sizing) coated over the piezoelectric particles and surface of the electrically non-conductive fiber to adhere the piezoelectric particles more strongly to the surface of the fiber. The fiber composition described above may also be embedded or integrated (e.g., incorporated, or homogeneously incorporated) into a solid matrix, such as a polymer, ceramic, or glassy carbon matrix, to produce a fiber composite. Notably, the electrically non-conductive property of the fiber advantageously facilitates charge separation, which in turn facilitates collection of strain-induced electrical responses at the surface of the material in which it is incorporated. The strain-induced electrical response may result from, for example, formation of defects or other stress or strain events in the material.

In another aspect, the present disclosure is directed to a method of producing the fiber composition described above. The method includes: (a) coating a fiber having a surface with a liquid suspension containing piezoelectric particles suspended in a solvent; and (b) removing the solvent to result in the piezoelectric particles adhered to the surface of the fiber. The fiber may be electrically conductive or electrically non-conductive. The end result of the foregoing process is a fiber composition containing: (i) a fiber having a surface; and (ii) piezoelectric particles adhered to the surface of the fiber. In some embodiments, the method further includes: (c1) thermal treating the fiber coated with piezoelectric particles as produced in step (b) to adhere the piezoelectric particles more strongly to the surface of the fiber. In alternative embodiments, the method further includes: (c2) coating the fiber coated with piezoelectric particles as produced in step (b) with a sizing agent to adhere the piezoelectric particles more strongly to the surface of the fiber. In some embodiments, the method may further include a combination of steps (c1) and (c2). The method may alternatively or in addition further include a step of incorporating the coated fiber into a matrix to produce a fiber composite. In some embodiments, the fiber is continuous (typically, at least 1 meter in length) or in the form of smaller segments (typically, having a size of 0.1-10 cm or 0.1-5 cm).

In another aspect, the present disclosure is directed to a method of detecting formation of defects in a material in which piezoelectric particles are incorporated. In the method, electrodes in electrical communication are attached to a material in which piezoelectric particles are incorporated, and a baseline voltage is read between the electrodes. The voltage is then monitored over time, wherein a voltage spike indicates formation of a defect or failure. In some embodiments, the piezoelectric particles in the material are adhered to fibers also incorporated into the material, which corresponds to the fiber composition described earlier above incorporated into a matrix.

In another aspect, the present disclosure is directed to a method of generating electrical energy (i.e., energy harvesting) from ambient vibration. In the method, a material in which piezoelectric particles are incorporated is placed in a location prone to ambient vibration, and electrodes in electrical communication are attached to the material to result in conversion of the ambient vibration into electrical energy transmitted through the electrodes. In some embodiments, the piezoelectric particles in the material are adhered to fibers also incorporated into the material, which corresponds to the fiber composition described earlier above incorporated into a matrix.

As further discussed below, this work demonstrates a multifunctional fiber-reinforced composite with passive self-sensing, energy-harvesting, and damage detection capabilities. More particularly, piezoelectric microparticles are deposited on fibers by a scalable, low-cost, environmentally friendly continuous feed-through or batch-wise process. When the coated fibers are incorporated into a matrix, the resulting composite may possess a superior interlaminar shear strength provided by the particle-modified fiber-matrix interfaces. The composite also possesses passive self-sensing capabilities that produce electrical signals proportional to various dynamic loading events. Vibration- and strain-controlled experiments have herein been performed on composite beams to quantify the sensitivity and power output as a function of input acceleration and strain. These composite-generated electrical signals are also used to detect in situ damage initiation or composite damage as part of a structural health monitoring program to detect such events prior to more widespread structural failure. In particular embodiments, the multifunctional composite described herein may simultaneously display a sensitivity of 0.5-2.6 mV/g at a resolution of 0.045-0.20 g (g=gravitational acceleration), energy harvesting in the range of nW/cc, and prediction of early damage by exhibiting 0.017-1.17 mV peaks in voltage-time history profiles while assuring ˜20% improved interlaminar shear strength.

### BRIEF DESCRIPTION OF THE FIGURES

FIG. 1. Schematic illustration of a fiber dip-coating process, as particularly directed to coating basalt fiber with piezoelectric particles (e.g., BaTiO₃ microparticles) followed by deposition of a sizing, such as an epoxy sizing.

FIGS. 2A-2E. Scanning electron microscope (SEM) images of clean (pristine) basalt fiber (FIG. 2A) and basalt fiber coated with the following wt % suspensions of BaTiO₃: 1 wt. % (FIG. 2B), 2 wt. % (FIG. 2C), 3 wt. % (FIG. 2D), and 4 wt. % (FIG. 2E), followed by coating with an epoxy sizing. Scale bars are 20 μm.

FIGS. 3A-3B. FIG. 3A is a plot of the average load-displacement responses of six specimens from nine series of composites containing basalt fibers incorporated into an epoxy matrix, wherein the nine series vary in the suspension concentration (0 to 4 wt % in 0.5 wt % increments) of BaTiO₃ used to coat the basalt fibers. The basalt fibers coated with BaTiO₃ particles were coated with an epoxy sizing before being incorporated into the epoxy matrix. FIG. 3B is a graph of apparent short beam shear strength (F_{sbs}) of six specimens from the nine sets of composites. Error bars signify the estimated F_{sbs} standard deviations for the six specimens from each set.

FIGS. 4A-4G. Microscopic images of the fractured surfaces of the following short beam shear test composite specimens: 0 wt. % BaTiO₃, i.e., pristine basalt fiber (FIG. 4A), 2 wt. % BaTiO₃ coating suspension on basalt fibers (FIG. 4B), and 4 wt. % BaTiO₃ coating suspension on basalt fibers (FIG. 4C), wherein each composite specimen contained basalt fibers coated with the indicated suspension wt % of BaTiO₃ particles and incorporated into an epoxy matrix. The pristine basalt fiber went through a coating process with the epoxy sizing only and no BaTiO₃ particles. The dotted lines highlight the cracked area. FIGS. 4D-4F show the respective binary images of FIGS. 4A-4C with highlighted pixels from the cracked areas. Scale bars are 400 μm. FIG. 4G plots the measured crack areas in different specimens as a function of BaTiO₃ concentrations.

FIGS. 5A-5B. Graph showing voltage output of the following test composite specimens: composite containing pristine basalt fibers (0 wt. % BaTiO₃, FIG. 5A) and composite in which basalt fibers were coated with 3.5 wt. % BaTiO₃ (FIG. 5B) subjected to a representative input excitation.

FIGS. 6A-6D. Noise level and RMS values of the recorded voltage responses are plotted together for the following test composite specimens in which basalt fibers were coated with the following concentrations of BaTiO₃ and incorporated into an epoxy matrix: 0.5 wt. % BaTiO₃ suspension (FIG. 6A), 3.5 wt. % BaTiO₃ suspension (FIG. 6B), and 4 wt. % BaTiO₃ suspension (FIG. 6C). Linear least-squares regression lines are also overlaid. FIG. 6D shows the average resolutions of all nine sets of specimens (i.e., epoxy matrix composites in which BaTiO₃ suspension concentrations of 0 to 4 wt % in 0.5 wt % increments were used to coat the basalt fibers). Error bars indicate the standard deviations of the estimated resolutions for three specimens from each set.

FIGS. 7A-7B. FIG. 7A plots the RMS values of the recorded voltage-time histories obtained from different composite specimens by vibrating them with various support excitations, and FIG. 7B plots their average sensitivities. Error bars in FIGS. 7A and 7B are the standard deviations of the RMS values of the measured signals and sensitivities of three specimens tested from each set of the composites, respectively.

FIGS. 8A-8C. RMS values of the voltage responses and the estimated power densities for the following test composite specimens in which basalt fibers were coated with the following concentrations of BaTiO₃ and incorporated into an epoxy matrix: 0.5 wt. % BaTiO₃ suspension (FIG. 8A), 3.5 wt. % BaTiO₃ suspension (FIG. 8B), and 4 wt. % BaTiO₃ suspension (FIG. 8C) at various load resistances.

FIGS. 9A-9G. FIG. 9A is a 3D plot summarizing the mechanical and electromechanical test results of the nine series of composites containing basalt fibers incorporated into an epoxy matrix, wherein the nine series vary in the suspension concentration (0 to 4 wt % in 0.5 wt % increments) of BaTiO₃ used to coat the basalt fibers.

FIGS. 9B-9G are plots showing the correlations between the different sensing properties (sensitivity, resolution, and power density) as compared to the F_{sbs} at various BaTiO₃ concentrations. The dotted lines in FIGS. 9B, 9C, and 9D) highlight the F_{sbs} of the pristine composites and the horizontal arrows indicate improving F_{sbs} properties. The vertical up and down_arrows in FIGS. 9A-9G indicate the targeted values for a better resolution, sensitivity, and power density, respectively.

FIGS. 10A-10C. Plots showing the applied load and the measured voltage across the following test composite specimens in which basalt fibers were coated with the following concentrations of BaTiO₃ and incorporated into an epoxy matrix: pristine (0 wt. % BaTiO₃, FIG. 10A), 3.5 wt. % BaTiO₃ suspension (FIG. 10B), and 4 wt. % BaTiO₃ suspension (FIG. 10C) during a damage detection study. The voltage outputs at the point of damage initiations are highlighted.

### DETAILED DESCRIPTION OF THE INVENTION

In a first aspect, the present disclosure is directed to a fiber composition that can be incorporated into a material to impart strength to the material and at the same time function to detect defects in the material and/or generate electrical energy from the material. The fiber composition includes at least the following components: (i) a fiber having a surface, particularly an electrically non-conductive fiber having a surface; and (ii) piezoelectric particles adhered to the surface of the fiber, particularly an electrically non-conductive fiber. In some embodiments, the fiber composition contains only the foregoing two components. In some embodiments, the fiber composition further includes a sizing agent coated over the piezoelectric particles and surface of the fiber, particularly an electrically non-conductive fiber. The fiber composition may, in some embodiments, include only the following three components: (i) a fiber having a surface, particularly an electrically non-conductive fiber having a surface; (ii) piezoelectric particles adhered to the surface of the fiber, particularly an electrically non-conductive fiber; and (iii) a sizing agent coated over the piezoelectric particles and surface of the electrically non-conductive fiber.

The electrically non-conductive fiber can be any of the fibers well known in the art that are substantially or completely electrically non-conductive. The electrically non-conductive fiber may have any of the known compositions, such as basalt, glass, polymer, and ceramic. Basalt fiber, in particular, is well known in the art, as evidenced by V. Dhand et al., Composites Part B Engineering, 73, 166-180, May 2015, which is herein incorporated by reference.

The term “fiber,” as used herein, refers to an object having a length dimension substantially longer (typically, at least ten times longer) than its width dimension, wherein the width of the fiber is typically no more than 1000 microns for purposes of the present invention. The ratio of the length to the width is commonly referred to as the “aspect ratio” of the fiber. The fiber typically has an aspect ratio of at least or greater than 100, 500, or 1000. In some embodiments, the aspect ratio may be, for example, at least or greater than 2,000, 5,000, or 10,000. In some embodiments, the fiber is referred to as “continuous,” which generally corresponds to a length of at least 1 meter. The continuous fiber may be produced in a continuous processing operation in which the produced fiber is held in a reel (or creel), with long lengths (e.g., tens or hundreds of meters, or kilometers) of the fiber coiled (i.e., wound) within the reels. The fiber may also be in the form of smaller segments than a continuous fiber. In some embodiments, the smaller segments are produced by chopping of a continuous fiber. The continuous fiber is typically chopped into pieces having a length of at least or greater than 0.1 cm (1 mm) and less than 1 meter (1000 mm) or 100 mm. In different embodiments, the smaller segment fibers have a length of, for example, 1, 2, 3, 4, 5, 10, 20, 30, 40, or 50 mm, or a length within a range bounded by any two of the foregoing values (e.g., 1-50 mm, 2-50 mm, or 3-50 mm). In some embodiments, the smaller segments of fiber also possess an aspect ratio of at least 1000, while in other embodiments, the smaller segments of fiber are not as restricted in the aspect ratio, e.g., an aspect ratio of at least or greater than 5, 10, 20, 50, 100, 200, or 500 (or range therein). Chopped segments of the foregoing lower aspect ratio may result from fine chopping (e.g., 0.1-1 cm segments) of a continuous fiber having an appreciable width (e.g., 50, 100, or 200 microns). Notably, a continuous fiber may also be defined as a fiber that extends an entire length of a fiber-matrix composite while a chopped fiber may also be defined as fibers that do not extend an entire length of a fiber-matrix composite. In some embodiments, the fiber is not a carbon fiber or carbide fiber.

An individual strand or filament of the fiber generally possesses a thickness of at least or greater than 1 micron. Since the aspect ratio of the fiber is typically at least 1000, the minimum thickness of 1 micron also sets a minimum length of at least 1000 microns (i.e., 1 mm, or 0.1 cm). In different embodiments, the individual filament possesses a thickness of at least or greater than 1, 2, 5, 10, 20, 30, 40, 50, or 100 microns. A tow of fiber includes a multiplicity (typically, several thousand) of individual filaments and typically has a thickness of at least 10, 50, or 100 microns and up to, for example, 100, 500, or 1000 microns. Notably, the macroscopic length and width dimensions provided above for the fiber do not correspond with the lengths or widths typical of nanoscopic fibers or particles, such as carbon nanotubes. For purposes of the present invention, the term “fiber” excludes the known nanoscopic fibers and particles, such as nanotubes, nanofibers, fullerenes, and the like.

In the case of a polymer fiber, the fiber can have any of the polymeric compositions of the art, particularly those polymeric compositions capable of imparting strength and other desirable mechanical properties to a material in which it is incorporated. The composition of the polymer fiber may be or include, for example, polyethylene, polypropylene, polyacrylate, aramid, polybenzoxazole, polyetherimide, nylon, polyester, polyhydroquinone-diimidazopyridine, polyether ether ketone, or polyacrylonitrile.

In the case of a ceramic fiber, the fiber can have any of the ceramic compositions of the art. For purposes of the present invention, the term “ceramic” is distinct from glass or silicon oxide. The ceramic fiber typically has or includes an oxide, nitride, boride, or carbide composition. Some examples of oxide ceramics include alumina, mullite, and metal oxides (e.g., zirconia or titania). Some examples of nitride ceramics include silicon nitride and boron nitride. An example of a boride ceramic is titanium boride. Some examples of carbide ceramics include silicon carbide, titanium carbide, and zirconium carbide. In some embodiments, any one or more of the foregoing classes or specific types of ceramic fiber compositions are excluded from the fiber composition or composite.

The piezoelectric particles (adhered to the surface of the electrically non-conductive fiber) can have any of the piezoelectric compositions known in the art. In some embodiments, the piezoelectric particles are also ferroelectric, while in other embodiments, the piezoelectric particles are not also ferroelectric. The term “adhered to,” as used herein, includes any suitable interaction between the fiber and particles by which the particles can be adhered, including, for example, physisorption and/or chemisorption, and may include some level of ionic and/or hydrogen bonding. The piezoelectric particles are typically included on the fibers in an areal density of at least 2%, 5%, or 10% and up to a maximum areal density before the onset of agglomeration of the particles. For purposes of the present invention, the piezoelectric particles are preferably substantially or completely unagglomerated and not in contact with each other while adhered to the fiber. Typically, the areal density of the piezoelectric particles on the fibers can be as high as 30%, 40%, 50%, or 60% before the onset of agglomeration of the particles. In the case of the fiber composition incorporated into a matrix to form a composite, the piezoelectric particles may be included in an amount of at least 0.1, 0.2, 0.3, 0.4, or 0.5 wt % and up to 1, 2, 3, 4, 5, 6, 7, 8, 9, or 10 wt % by total weight of the composite. The piezoelectric particles may alternatively be included in the composite in an amount within a range bounded by any two of the foregoing values, e.g., 0.1-10 wt %, 0.2-10 wt %, 0.3-10 wt %, 0.1-8 wt %, 0.2-8 wt %, 0.3-8 wt %, 0.5-10 wt %, 0.5-8 wt %, 1-10 wt %, or 1-8 wt %.

In a first set of embodiments, the piezoelectric particles have a particle size of at least 100 nm. The term “particle size of at least 100 nm” means that at least one or two (or all) dimensions of the particles have a length of at least 100 nm. For example, the piezoelectric particles may have a particle size of precisely, about, at least, or above 100 nm, 150 nm, 200 nm, 250 nm, 300 nm, 400 nm, 500 nm, or 1000 nm (1 micron), or a precise or approximate size within a range bounded by any two of the foregoing values or a variation in size within a range bounded by any two of the foregoing values. In a second set of embodiments, the piezoelectric particles have a particle size of up to or less than (i.e., no more than) 100 nm. The term “particle size of up to or less than 100 nm” means that at least one or two (or all) dimensions of the particles have a length of up to or less than 100 nm. For example, the piezoelectric particles may have a particle size of precisely, about, up to, or less than 100 nm, 80 nm, 50 nm, 40 nm, 30 nm, 20 nm, or 10 nm, or a precise or approximate size within a range bounded by any two of the foregoing values or a variation in size within a range bounded by any two of the foregoing values. In some embodiments, the piezoelectric particles have a size or variation in size within a range spanning across values provided in the first and second embodiments above, e.g., 10-1000 nm or 10-500 nm. Although any particle shape of the piezoelectric particles is considered herein, the piezoelectric particles typically have a shape containing edges and corners, e.g., a polyhedral shape (e.g., prismatic, pyramidal, or platonic solid) or plate-like shape, all of which correspond to a crystalline structure.

The piezoelectric particles can have any of the compositions known in the art having a piezoelectric property. The piezoelectric composition is typically a metal oxide composition. In some embodiments, the piezoelectric particles have a perovskite composition, as well known in the art. The perovskite composition typically has the general structure M′M″O₃, wherein M′ and M″ are typically different metal cations, provided that the composition has a piezoelectric property. The perovskite composition may more specifically be a halide perovskite composition. Some examples of piezoelectric compositions include barium titanate (BaTiO₃ and related compositions), lead zirconate titanate (Pb(ZrₓTi₁₋ₓ)O₃, with 0≤x≤1 or 0<x<1, more typically 0.3≤x≤0.6), potassium niobate (KNbO₃ and related compositions), sodium potassium niobate (KₓNa₁₋ₓNbO₃, with 0≤x≤1 or 0<x<1, such as K_{0.5}Na_{0.5}NbO₃), and bismuth ferrite (BiFeO₃ and related compositions). The piezoelectric particles may, in some embodiments, have a composition based on PZT, such as a morphotropic phase boundary (MPB) composition, e.g., Pb(Zn_{1/3}Nb_{2/3})O₃—PbTiO₃ (PZN—PT) or Pb(Mg_{1/3}Nb_{2/3})O₃—PbTiO₃ (PMN—PT). The piezoelectric particles may alternatively have a simple oxide structure, such as zinc oxide (ZnO) and related compositions. The piezoelectric composition may also be, for example, a bismuth titanate, such as BiTiO₃, Bi₁₂TiO₂₀, or Bi₄Ti₃O₁₂ and related compositions (e.g., Bi_{0.5}Na_{0.5}TiO₃). The term “related compositions” typically refers to doped versions, such as bismuth-doped, lanthanum-doped, iron-doped, or strontium-doped versions of any of the foregoing compositions, provided that the doped material maintains a piezoelectric property.

As noted earlier above, the fiber composition may further include a sizing agent coated over the piezoelectric particles and surface of the electrically non-conductive fiber. The sizing agent can be any of the sizing agents well known in the art. The sizing agent is typically selected to be compatible with or bond with a matrix in which the fiber is to be incorporated. As well known in the art, a sizing agent is a polymeric material included on a fiber to increase the interfacial strength between the fiber and a polymeric matrix in which the fiber is incorporated. The sizing agent may also facilitate ease of handling and protect the fiber surface during handling. The sizing agent typically has a thickness of up to or less than 200 nm when deposited on the fiber surface. In different embodiments, the sizing agent has a thickness of up to or less than 1000, 500, 400, 300, 200, 150, 100, 75, 50, 40, 30, 20, 10, or 5 nm, or a thickness within a range bounded by any two of the foregoing values. Sizing agents are described in detail in, for example, R. Zhang et al., Journal of Applied Polymer Science, 125(1), July 2012 and U.S. Pat. No. 9,932,703, the contents of which are herein incorporated by reference. The sizing agent may be, for example, an epoxy, polyester, or polyurethane resin, and typically an aromatic-containing resin. Epoxy sizing agents, in particular, are described in, for example, P. Ren et al., Polymer Composites, 27(5), 591-598, October 2006, U.S. Pat. Nos. 9,617,398, and 5,298,576, the contents of which are herein incorporated by reference. Amine-containing sizing agents are also described in U.S. Pat. No. 9,617,398. Vinyl ester resin emulsion type sizing agents are described in, for example, W. Ding et al., Asian Journal of Chemistry, 25(14), 7955-7958, 2013, the contents of which are herein incorporated by reference.

In particular embodiments, the sizing agent is an epoxy sizing agent (i.e., contains epoxy groups). Typically, the epoxy sizing agent is a resin (polymer) possessing at least two epoxide groups, and thus, can be a difunctional, trifunctional, tetrafunctional, or a higher functional epoxy resin. In some embodiments, the epoxide group is present as a glycidyl group. The epoxy resin can be conveniently expressed by the following generic structure:

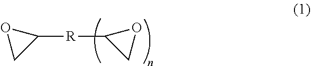

In Formula (1), n is precisely or at least 1, 2, 3, 4, 5, 6, or any suitable number, including a higher number (e.g., 10, 20, 30, 40, or 50) typical for a polymer having epoxide-containing units. The group R is a saturated or unsaturated hydrocarbon linking group having at least one and up to any suitable number of carbon atoms. In different embodiments, R can have precisely or at least, for example, 1, 2, 3, 4, 5, 6, 7, 8, 9, 10, 12, 15, 18, 20, 25, 30, 35, 40, or 50 carbon atoms, or a number of carbon atoms within a range bounded by any two of these values. The saturated hydrocarbon group suitable as R may be or include, for example, a straight-chained or branched alkylene group or cycloalkylene group. Some examples of saturated R linkers include methylene (i.e., —CH₂—), ethylene (i.e., —CH₂CH₂—), n-propylene (i.e., —CH₂CH₂CH₂—, or “trimethylene”), isopropylene (—CH(CH₃)CH₂—), tetramethylene, pentamethylene, hexamethylene, —C(CH₃)₂CH₂—, —CH(CH₃)CH(CH₃)—, —CH₂C(CH₃)₂CH₂—, cyclopropylene (i.e., cyclopropyldiyl), 1,3-cyclobutylene, 1,2-cyclopentylene, 1,3-cyclopentylene, 1,2-cyclohexylene, 1,3-cyclohexylene, and 1,4-cyclohexylene. Some examples of unsaturated R linkers include straight-chained or branched alkenylene or alkynylene groups or cycloalkenylene groups, such as vinylene (—CH═CH—), allylene (—CH₂—CH═CH—), —CH₂—CH₂—CH═CH—, —CH₂—CH═CH—CH₂—, —CH═CH—CH═CH—, ethynyl, ethynyl-containing hydrocarbon groups, 1,3-cyclopentenediyl, 1,4-cyclohexenediyl, as well as aromatic linking groups, such as 1,2-, 1,3-phenylene, 1,4-phenylene, 4,4′-biphenylene, naphthalen-1,5-diyl, and bisphenol A ether groups. The foregoing exemplary linking groups for R are suitable for linking two epoxide groups. However, a generic set of trifunctional, tetrafunctional, and higher functional epoxy resins are also considered herein wherein one, two, or a higher number of hydrogen atoms from any of the exemplified linking groups provided above for R are replaced by one, two, or a higher number of epoxide groups, respectively (e.g., 1,3,5-triglycidylbenzene). Any two, three, or more linking groups identified above can be linked together as well, such as two methylene groups on a phenylene group, i.e., —CH₂—C₆H₄—CH₂—.

In some embodiments, the R linking group contains only carbon and hydrogen atoms. In other embodiments, the R linking group also includes one, two, three, or more heteroatoms or heteroatom groups. The heteroatoms are typically one or more selected from oxygen (O), nitrogen (N), sulfur (S), or a halogen, such as, for example, fluorine, chlorine, bromine, and iodine atoms. Heteroatoms can be included as, for example, ether (—O—), amino (—NH—, —N═, or as a tertiary amine group), or thioether. Some heteroatom groups include hydroxy (OH), carbonyl (—C(═O)—), organoester (—C(═O)O—), amide (—C(═O)NH—), urea, carbamate, and the like. The heteroatom or heteroatom-containing group can either insert between two carbon atoms engaged in a bond, or between carbon and hydrogen atoms engaged in a bond, or replace a carbon or hydrogen atom. A particular example of a linking group R containing two oxygen atoms is bisphenol A, which is typically di-etherified with glycidyl groups.

In particular embodiments, the epoxy sizing agent is a glycidyl derivative, which can be conveniently expressed as a sub-generic formula of Formula (1) above by the following structural formula:

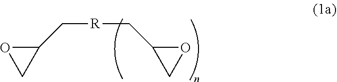

The glycidyl derivative can be any of those compounds containing glycidyl groups, typically produced by reacting epichlorohydrin with a polyhydric molecule, such as a dihydric, trihydric, or tetrahydric molecule. The polyhydric molecule can be, for example, a polyhydric alcohol, i.e., polyol (e.g., diol, triol, or tetrol, or generically defined as R—(OH)ₙ where n is as above except that it is a minimum of 2), polyamine (e.g., diamine, triamine, or tetramine), or polycarboxylic acid (e.g., malonic, succinic, glutaric, adipic, or terephthalic acids). The linking group may also be a hydroxy-containing polymeric structure resulting from ring-opening polymerization of epoxy groups.

Some particular examples of difunctional epoxy sizing agents include diglycidyl ethers of a diol (i.e., glycol), wherein some examples of diols include ethylene glycol, diethylene glycol, triethylene glycol, propylene glycol, 1,3-propanediol, 1,4-butanediol, 1,5-pentanediol, 1,6-hexanediol, tetraethylene glycol, pentaethylene glycol, bisphenol A, bisphenol AF, bisphenol S, bisphenol F (e.g., as present in Epon™ 862), neopentyl glycol, 2,2,4,4-tetramethyl-1,3-cyclobutanediol, catechol, resorcinol, dihydroxyquinone, thiodiglycol, and 4,4′-dihydroxybiphenyl. In some embodiments, the epoxy sizing agent is an epoxy prepolymer resin of the following general formula (Formula 2) (where m can be 0, 1, 2, 3, 4, 5, 10, or a number up to, for example, 20, 25, 30, 40, or 50 or a number within a range bounded by any two of these values):

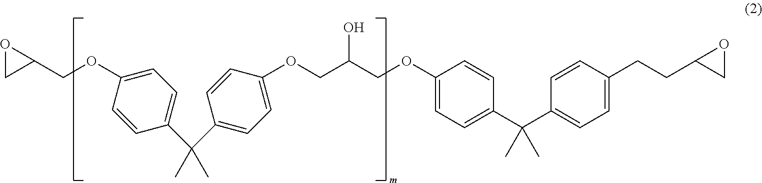

Some particular examples of trifunctional and tetrafunctional epoxy resins include triglycidyl and tetraglycidyl ethers of a triol or tetrol, respectively, wherein some examples of triols include glycerol, 1,3,5-trihydroxybenzene (phloroglucinol), trimethylolethane, trimethylolpropane, triethanolamine, and 1,3,5-triazine-2,4,6-triol (cyanuric acid). An example of a tetrol is pentaerythritol.

The difunctional, trifunctional, tetrafunctional, or higher functional epoxy resin can also be, for example, a diglycidyl, triglycidyl, tetraglycidyl, or higher polyglycidyl ether of a phenol novolak resin or bisphenol A novolak resin. Such resins are well known in the art, as described, for example, in U.S. Pat. No. 6,013,730, which is herein incorporated by reference in its entirety.

In some embodiments, the sizing agent is partially or fully cured with a difunctional or higher functional molecule capable of crosslinking reactive (e.g., epoxy, amine, or vinyl) groups on the sizing agent. In the case of an epoxy sizing agent, the curing agent includes epoxy-reactive groups, such as, for example, hydroxy (e.g., alcohol or phenol), carboxylic acid, thiol, amine, or amide groups. Typically, the curing agent is a polyamine, such as a diamine, triamine, tetramine, or higher polyamine, such as an amine-containing polymer, wherein it is understood that the polyamine contains at least two amino groups selected from primary, secondary, and tertiary amines. The polyamine can be conveniently expressed as R—(NH₂)ₙ, wherein R and n are as defined above in Formula (1). In some cases, one or two hydrogen atoms of the amino group may be replaced with a linker R or a hydrocarbon group (a protonated form of any of the linking groups R), which may itself also contain a primary, secondary, or tertiary amine group. Some examples of polyamine curing agents include ethylene diamine (EDA), diethylenetriamine (DETA), triethylenetetramine (TETA), tetraethylenepentamine (TEPA), piperazine, guanidine, 2-cyanoguanidine (dicyandiamide), aromatic amines (e.g., diaminobenzene, methylenedianiline, and 3,3′- and 4,4′-diaminodiphenylsulfones), polyethylene glycol-based polyamines (e.g., triethylene glycol diamine or tetraethylene glycol diamine, or as provided by the commercially available polyetheramine JEFFAMINE® series of compositions), m-phenylenediamine, imidazole, 2-methylimidazole, diethylaminopropylamine, isophoronediamine, m-xylenediamine, as well as their N-alkyl (e.g., N-methyl or N-ethyl) analogs, provided that at least two amino or amido groups selected from primary and secondary amines are provided in the curing agent.

In another aspect, the present disclosure is directed to a solid composite material in which the fiber composition, as described above, is embedded (i.e., incorporated) within a matrix. In the solid composite material, the fiber composition is embedded (e.g., incorporated, or homogeneously incorporated) within the matrix. The matrix may be, for example, a polymer, ceramic, glass, or glassy carbon matrix. In the case of a polymer matrix, the polymer is typically suitable for use in a high strength application. The polymer matrix can be a thermoplastic or thermoset. The polymer matrix may be, for example, an epoxy-derived matrix, such as any of the cured epoxy formulations described above for the sizing agent. In particular embodiments, the polymer matrix is an epoxy-amine or epoxy-amide matrix. In the case of a ceramic matrix, the ceramic may be, for example, carbon, silicon carbide, alumina, mullite, or nitride ceramic.

In some embodiments, the polymer matrix results from vinyl-addition polymerization of an unsaturated precursor resin or unsaturated monomers. By being unsaturated, the precursor resin or monomer contains carbon-carbon double bonds. The polymeric matrix can be derived from, for example, curing any of the acrylate or methacrylate monomers known in the art (e.g., acrylic acid, methacrylic acid, methylmethacrylate, hydroxyethylmethacrylate), acrylonitrile, ethylene, propylene, styrene, divinylbenzene, 1,3-butadiene, cyclopentene, vinyl acetate, vinyl chloride, or a cycloolefin (e.g., cyclohexene, cycloheptene, cyclooctene, or norbornene), or a fluorinated unsaturated monomer, such as vinylidene fluoride, fluoroethylene, or tetrafluoroethylene, or a bromated unsaturated monomer (e.g., DGEBA-based vinyl ester monomer with bromo substitution on the aromatic ring). The polymer matrix can be a homopolymer, or alternatively, a copolymer, e.g., block, random, alternating, or graft copolymer of two or more different types of monomers, such as any of those mentioned above.

The polymer matrix may alternatively be any of the condensation polymers known in the art. The condensation polymer can be, for example, a polyester, polyamide, polyurethane, or phenol-formaldehyde, or a copolymer thereof, or a copolymer with any of the addition polymers described above. In some embodiments, the polymer matrix is a thermoplastic selected from polyether ether ketone (PEEK), polycarbonates, polymethacrylic acids, polyesters, polylactic acids, polyglycolic acids, thermoplastic polyurethanes, polymethacrylates, polymethylmethacrylates, Nylon 6, Nylon 6,6, polysulfones, polyvinylalcohols, and polyimides.

In some embodiments, the polymer matrix is derived from a vinyl ester resin by curing methods well-known in the art. Vinyl ester resins are known to possess terminal carbon-carbon double bonds. As known in the art, a vinyl ester resin is generally formed by reaction between a diepoxide, triepoxide, or higher polyepoxide (e.g., as described above under Formulas 1, 1a, and 2) and an unsaturated monocarboxylic acid, such as acrylic or methacrylic acid. The general process for producing an exemplary difunctional divinyl ester is provided as follows:

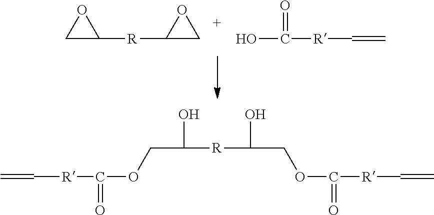

In the above scheme, an exemplary set of difunctional divinyl ester products are depicted in which R is as defined above and R′ is either a bond or a hydrocarbon linker R, as defined above. In particular embodiments, the diepoxy molecule depicted in the above scheme is diglycidyl ether of bisphenol A (DGEBA).

In some embodiments, the polymer matrix is derived from an unsaturated polyester resin. Unsaturated polyester resins are known to possess internal carbon-carbon double bonds. As known in the art, an unsaturated polyester resin is generally formed by reaction between a diol, triol, tetrol, or higher polyol, such as any of the polyols described above, and an unsaturated di- or tri-carboxylic acid, such as maleic, phthalic, isophthalic, or terephthalic acid. The general process for producing an exemplary unsaturated polyester resin is provided as follows:

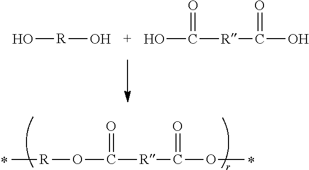

In the above scheme, an exemplary set of unsaturated polyester resin products are depicted in which R is as defined above and R″ is an unsaturated hydrocarbon linker containing a reactive alkenyl group, such as any of the unsaturated hydrocarbon linkers defined for R above containing this feature, and r is generally at least 1, 2, 3, 4, or 5, and up to 6, 7, 8, 9, 10, 12, 15, 18, or 20 (or any range bounded by any two of these values). The diol HO—R—OH shown in the above scheme may be replaced with or combined with a triol, tetrol, or higher functional alcohol, or generically defined as R—(OH)ₙ where n is as above except that it is a minimum of 2, and the dicarboxy molecule depicted in the above scheme can be replaced with or combined with a tricarboxy or higher carboxy molecule. In particular embodiments, the polyol is selected from a polyethylene glycol, such as ethylene glycol, diethylene glycol, and triethylene glycol, and the polycarboxy is selected from maleic acid, phthalic acid, isophthalic acid, and terephthalic acid.

In another aspect, the present disclosure is directed to a method of producing a fiber composition in which a fiber is coated with piezoelectric particles. As further discussed below, the process includes conditions by which the piezoelectric particles become adhered to the surface of the fiber. In one set of embodiments, the fiber is electrically non-conductive, as described above (e.g., basalt, glass, polymer, or ceramic). In another set of embodiments, the fiber is electrically conductive, such as a carbon fiber or metallic fiber. In some embodiments, the fiber may be semi-conductive, such as silicon or germanium fibers.

In the process, a fiber is coated with a liquid suspension that contains piezoelectric particles suspended in a solvent. The liquid emulsion may be deposited on the fiber surface by any suitable means, such as dip coating, spray coating, brush coating, and electrospraying. The piezoelectric particles can have any of the compositions, sizes, and other attributes as described earlier above. The liquid suspension may be a mechanical suspension or a stable suspension. As well known, a mechanical suspension relies on mechanical agitation to maintain the particles in a suspended state, while a stable suspension maintains the particles in a suspended state without the need for mechanical agitation. In some embodiments, the suspension includes a surfactant to improve the stability of the suspension. In other embodiments, the suspension excludes a surfactant. In some embodiments, the suspension contains only the piezoelectric particles and solvent. In some embodiments, the suspension contains only the piezoelectric particles and solvent, except that a surfactant or auxiliary agent (e.g., pH controlling or defoaming agent) may be included or excluded. The piezoelectric particles can be included in the suspension in any desired amount, preferably before the onset of an appreciable level of agglomeration, typically in an amount of, for example, 0.1 wt %, 0.2 wt %, 0.5 wt %, 1 wt %, 1.5 wt %, 2 wt %, 2.5 wt %, 3 wt %, 3.5 wt %, 4 wt %, 4.5 wt %, 5 wt %, 6 wt %, 7 wt %, 8 wt %, 9 wt %, or 10 wt %, or an amount within a range bounded by any two of the foregoing values (e.g., 0.5-4 wt %, 0.5-3.5 wt %, 0.5-3 wt %, 0.5-2.5 wt %, or 0.5-2 wt %).

The solvent used in the suspension can be any solvent in which the piezoelectric particles can be suspended and which does not react with the piezoelectric particles or fiber. Typically, the solvent has a boiling point of no more than or less than 200° C., 150° C., or 100° C., to permit more facile drying in the next step. In particular embodiments, the solvent used in the suspension is aqueous-based, wherein the term “aqueous-based” herein includes 100% water (e.g., deionized or ultrapure water) or an aqueous solvent mixture which contains less than 100% water. The aqueous solvent mixture includes water admixed with a water-miscible solvent. The water may be present in the aqueous-solvent mixture in any amount, e.g., precisely, about, at least, or greater than 1, 2, 5, 10, 20, 30, 40, 50, 60, 70, 80, 90, 95, 98, or 99 vol %, or an amount within a range bounded by any two of the foregoing values, with remainder being the water-miscible solvent. The water-miscible solvent may be, for example, a water-miscible alcohol (e.g., methanol, ethanol, or isopropanol), a ketone (e.g., acetone), a nitrile (e.g., acetonitrile), or amide or lactam (e.g., DMF or NMP). In other embodiments, the solvent used in the suspension is non-aqueous by being substantially or completely devoid of water (e.g., no more than or less than 0.1 vol %, or 0 vol %, respectively). The non-aqueous solvent may be water-miscible or water-immiscible. The non-aqueous solvent may be, for example, a hydrocarbon (e.g., hexanes), halohydrocarbon (e.g., methylene chloride or chloroform), alcohol, ketone, nitrile, or amide.

After the fiber is coated with the suspension containing piezoelectric particles, the coated fiber is subjected to conditions under which the solvent from the suspension residing on the fiber surface is removed. The drying process may be achieved by subjecting the fiber to drying conditions conducive for evaporating the solvent, e.g., rapid air flow and/or an elevated temperature (typically no more than about 100° C.). In some embodiments, the fiber is passed through a drying chamber in which the fiber is subjected to any of the foregoing drying conditions. The fiber may alternatively be permitted to dry over time with no energy input.

In some embodiments, the dried fiber coated with piezoelectric particles (i.e., “dried fiber”) is subjected to a process that more strongly adheres the piezoelectric particles to the surface of the fiber. In one embodiment, the dried fiber is thermally treated at a sufficiently high temperature to result in sintering. The sintering temperature is typically above 100° C., e.g., at least or up to 150° C., 200° C., 250° C., 300° C., 350° C., 400° C., 450° C., or 500° C., or a temperature within a range bounded by any two of the foregoing values. In another embodiment, the dried fiber is coated with a sizing agent, such as any of the sizing agents described earlier above, to adhere the piezoelectric particles more strongly to the surface of the fiber. To coat the dried fiber with a sizing agent, the dried fiber may initially be coated with a solution containing the sizing agent dissolved in a solvent, followed by removal of the solvent to leave only the sizing agent coating. The sizing coating process is typically conducted at ambient temperature and pressure. In some embodiments, the dried fiber may be thermally treated at a sintering temperature followed by coating with a sizing agent. In some embodiments, sintering is optional or is not used. The sizing agent can be included in the sizing solution in any desired concentration, but typically in an amount no more than about 30% by weight of the total of sizing agent and solvent, such as 0.01%, 0.05%, 0.1%, 0.2%, 0.5%, 1%, 2%, 5%, 10%, 15%, 20%, or 25% by weight, or a weight within a range bounded by any two of the foregoing values.

Following the above sizing coating and drying step, the fiber coated with a sizing may, in some embodiments, be subjected to a sizing curing process. The sizing agent on the coated fiber may be reacted with a crosslinking (curing) agent, such as described above, by dip coating, spraying, or brushing the coated fiber with a solution containing a crosslinking agent. The fiber is typically again dried after the crosslinking step. If desired, a second coating of the same or different sizing agent may be applied to the fiber surface and a second coating of curing agent applied thereafter. In other embodiments, a solution containing an admixture of the sizing agent and curing agent is coated onto the fibers, and the fibers are subsequently subjected to a curing process to induce a crosslinking reaction between the sizing agent and curing agent.

In some embodiments, before the fiber has been coated with the piezoelectric particles and optionally a sizing agent, the fiber is subjected to a process that functionalizes the fiber surface with reactive groups that can form a stronger interaction with the piezoelectric particles and/or sizing agent. For example, the fibers may be subjected to a process in which hydroxyl (OH), carboxyl (COOH), and/or amino (e.g., NH₂) groups functionalize the surface of the fiber. Fibers can be surface-functionalized with such reactive groups by methods well known in the art, such as by an oxidative (e.g., plasma or chemical) surface treatment. Such surface-functionalized fibers may also be commercially available. In some embodiments, a carbon fiber is functionalized in the foregoing manner before being coated with the piezoelectric particles and optional sizing agent.

In some embodiments, before the fiber is coated with the liquid suspension of piezoelectric particles, the fiber undergoes a surface cleansing process. The fiber cleansing process may function to remove surface contaminants (e.g., oils) or a pre-existing sizing agent that may have been applied to the fiber by a commercial fiber manufacturer from which the fiber was obtained. The cleansing process typically entails treating the fiber surface with an organic solvent capable of dissolving a range of hydrophobic and hydrophilic substances, while not dissolving or adversely affecting the fiber itself. In the case of a non-polymeric fiber (e.g., basalt, glass, ceramic, or carbon), the solvent used for cleansing the fiber surface may be, for example, acetone, acetonitrile, methylene chloride, chloroform, or dimethylformamide. The fiber cleansing process may or may not also include mechanical rubbing of the surface.

In some embodiments, the fiber being coated with piezoelectric particles by the above process is a carbon fiber. The carbon fiber can be any of the high strength continuous carbon fibers well known in the art. Continuous carbon fibers and methods of producing them are described in detail in, for example, U.S. Pat. Nos. 9,732,445, 9,725,829, 9,528,197, 8,221,840, and 4,070,446, and X. Huang, Materials (Basel), 2(4):2369-2403, December 2009, the entire contents of which are herein incorporated by reference in their entirety. The carbon fiber may also be a chopped version of a continuous fiber. Some examples of carbon fiber compositions include those produced by the pyrolysis of polyacrylonitrile (PAN), viscose, rayon, pitch, lignin, and polyolefin fiber precursors. As well known in the art, the carbon fiber is generally produced by a process in which a carbon fiber precursor (such as any of those mentioned above) is subjected to a stabilization step before a carbonization step. The carbon fiber considered herein generally possesses a high tensile strength, such as at least 500, 1000, 2000, 3000, 5000, 8,000, or 10,000, with a degree of stiffness generally of the order of steel or higher (e.g., 100-1000 GPa). The term “carbon fiber,” as used herein, also includes carbon tapes, as well known in the art. The carbon fiber is made predominantly (e.g., at least 90, 95, 98, 99 or 100%) of elemental carbon, but minor amounts of some non-carbon species (e.g., nitrogen, phosphorus, boron, or silicon) may be present, generally in amounts up to or less than 10, 5, 2, or 1 wt %.

In another aspect, the present disclosure is directed to a method for producing a composite material in which the fiber composition is incorporated. In the method, fibers coated with the piezoelectric particles and optionally a sizing agent are integrated with (e.g., admixed with or incorporated into) a precursor matrix in liquid or powder form, and the precursor matrix is either cured or thermally treated and/or compressed to form the composite. In the case of a polymer matrix, the coated fiber is typically integrated with the polymer precursor resin by, for example, mixing the fiber with the polymer precursor resin or impregnating the polymer precursor resin into a standing (optionally continuous) fiber structure to produce an integrated precursor composite, before subjecting the integrated precursor composite to a curing process. The matrix precursor resin can be any of the precursor resins described above, e.g., an epoxy resin or an unsaturated precursor resin, such as a vinyl ester resin or unsaturated polyester resin. The coated fiber can be incorporated into a glass or ceramic matrix by methods well known in the art, such as chemical vapor deposition, liquid phase infiltration, polymer infiltration and pyrolysis, and hot press sintering. Notably, in these processes, the polymer sizing is typically pyrolyzed or vaporized.

The conditions used in curing precursor resins are well known in the art, and may rely on, for example, an elevated temperature, radiative exposure (e.g., UV, microwave, or electron beam), or both, as well as the use of an initiator, such as a peroxide (e.g., cumene hydroperoxide, butanone peroxide, t-butylperoxybenzoate, benzoyl peroxide, or MEKP) or Lewis acid (e.g., BF₃), and if applicable, a catalyst, such as a metal-containing catalyst, e.g., a ROMP catalyst. In particular embodiments, the curing step is conducted at a temperature selected from 100° C., 105° C., 110° C., 115° C., 120° C., 125° C., 130° C., 135° C., 140° C., 145° C., 150° C., 155° C., 160° C., 165° C., 170° C., 175° C., 180° C., or 185° C., or a temperature within a range bounded by any two of these values, for a curing time selected from, for example, 0.5, 1.0, 1.5, 2.0, 2.5, 3.0, 3.5, 4.0, 4.5, 5, 6, 7, or 8 hours, or a time within a range bounded by any two of these values, wherein it is understood that higher curing temperatures generally require shorter curing times to achieve the same effect. In some embodiments, a two-step or three-step curing process is used, wherein each step employs a different temperature. Moreover, the cure can be conducted at room temperature with the help of a promoter included in the resin, such as cobalt naphthenate, cobalt octoate, or cobalt acetylacetonate, and can be accelerated by the use of a catalyst, such as N,N-dimethylaniline and similar molecules.

In another aspect, the present disclosure is directed to a method for detecting formation of defects in a material in which piezoelectric particles are incorporated. Any selection of matrix and piezoelectric particles, as described above, may be included in the material. The material may optionally include fibers, such as any of those described above. The material may include piezoelectric particles with or without fibers also present in the material. In some embodiments, the piezoelectric particles are adhered to fibers (or a single continuous fiber structure) embedded in the matrix, as described above. The method entails first reading the baseline voltage between two electrodes in electrical communication placed on the surface of the material. The term “on the surface” also includes the possibility of embedding one or more electrodes below the surface of the material. The voltage is then monitored over time, wherein a voltage spike indicates formation of a defect, such as a crack or fracture in the material. The defect may occur in the matrix or in a fiber incorporated in the matrix or by matrix-fiber debonding. The material may be in the shape of (or may be a component of) a mechanical or structural component, such as a blade for a wind turbine, frame for a transport vehicle, or a wall, siding, roofing, or flooring for a building.

In another aspect, the present disclosure is directed to a method of generating electrical energy from ambient vibration in a material in which piezoelectric particles are incorporated. Any selection of matrix and piezoelectric particles, as described above, may be included in the material. The material may optionally include fibers, such as any of those described above. The material may include piezoelectric particles with or without fibers also present in the material. In some embodiments, the piezoelectric particles are adhered to fibers embedded in the matrix, as described above. The method entails first placing a material in which piezoelectric particles are incorporated in a location prone to ambient vibration. Electrodes in electrical communication are attached on the surface of the material to result in conversion of the ambient vibration into electrical energy. The term “on the surface” also includes the possibility of embedding one or more electrodes below the surface of the material. Notably, in some embodiments, the material in which piezoelectric particles are incorporated may be capable of a dual function of detecting defects and harvesting electrical energy either with the same electrodes or different electrodes on or in the same material.

Examples have been set forth below for the purpose of illustration and to describe certain specific embodiments of the invention. However, the scope of this invention is not to be in any way limited by the examples set forth herein.

### Examples

Overview

This work describes a continuous feed-through dip-coating process to fabricate a composite with passive sensing, energy harvesting, damage detection and potential failure prediction properties with an enhanced interlaminar shear strength (ILSS). BaTiO₃ crystals with particle size >200 nm are well-known for their superior piezoelectric property; therefore, they are leveraged in this work to manufacture the desired multifunctional structural composites. Here, basalt fiber tows were dip-coated with BaTiO₃ microparticles at various concentrations and used in a filament winding technique to manufacture composite test specimens. Basalt fibers are electrically insulating, thus facilitating electrical charge separation, which is one of the essential requirements for piezoelectric passive sensing and energy harvesting. Thus, the electrical charge generated by the deformation of composites can be collected at the surface electrodes for structural sensing and energy harvesting.

Upon fabricating the BaTiO₃-coated basalt fiber, the coating process was qualitatively assessed by scanning electron microscopy (SEM). The ILSS, passive sensing, and energy scavenging properties of the composites were systematically studied by extensive vibration and strain-controlled experiments, and the optimum loading of the BaTiO₃ microparticles has been determined. Upon characterizing their mechanical and electrical properties, the passive electrical responses of the composites were used for in situ damage initiation monitoring during short beam shear tests. The findings indicate that this scalable, low-cost continuous feed-through BaTiO₃ deposition process can be used to manufacture a multifunctional composite that exhibits an enhanced ILSS, passive structural sensing, and energy harvesting properties simultaneously.

Piezoelectric Microparticle Deposition

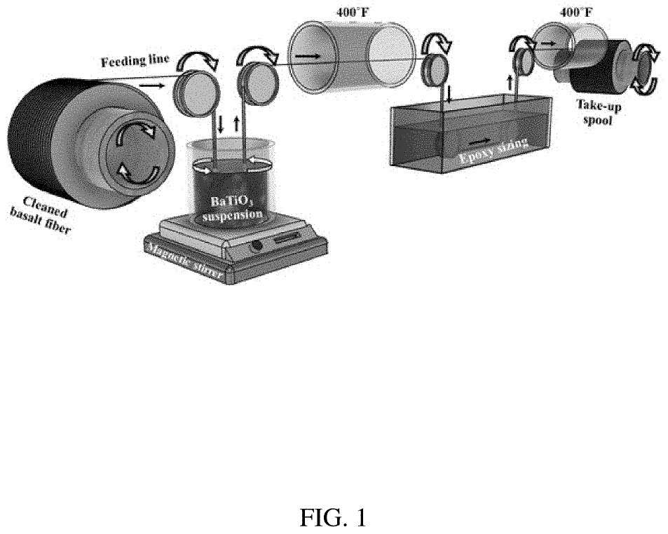

Unsized basalt fibers were coated with BaTiO₃ microparticles through a two-step dip-coating process. Fiber tows were dipped into water-based BaTiO₃ suspensions followed by an epoxy sizing bath. A schematic illustration of the process is shown in FIG. 1.

In the following experiments, nine sets of microparticle-deposited fibers were prepared by dip-coating them through water containing a suspension of BaTiO₃ microparticles at various concentrations (0 to 4 wt. % in 0.5 wt. % increments). It should be noted that the nomenclature of the fibers and composites followed in this study is referenced to the BaTiO₃ wt. % in the first bath (i.e., BaTiO₃ concentration in water).

Fiber Coating

First, the fibers were subjected to a cleaning process to remove the polymer sizing from the as-received fibers in order to later apply an epoxy emulsion sizing on the deposited BaTiO₃ microparticles. The fiber tows were continuously processed at a constant line feed rate of ˜40 m/h through methanol and acetone baths, which were separately added in the sizing line. The methanol chamber was continuously agitated with a magnetic stirrer at 400 rpm for a thorough cleaning. After each solution treatment, the fiber tows were dried in the sizing line while passing through two separate˜60-cm-long, 340° F. chambers.

After cleaning, the fiber tows were dip-coated with BaTiO₃ microparticles. This two-step process entailed dipping the fiber tows through a water-based suspension of BaTiO₃ microparticles followed by an epoxy sizing bath at a constant line feed rate (˜20 m/h). Like the first step of the fiber cleaning, BaTiO₃ suspensions were continuously agitated using the magnetic stirrer (˜400 rpm) to prevent their agglomeration and sedimentation in the water bath. A drying process followed this dip-coating step by passing the fibers through a 400° F. heating chamber in the sizing line. The dip-coated fibers were passed through an epoxy sizing bath and subsequently dried in a similar fashion. The epoxy sizing was a diluted epoxy emulsion (epoxy:water=1:40 by weight) prepared by mixing the epoxy in DI water. The dilution ensures the deposition of a thin layer of the sizing on the fiber surfaces to promote adherence of the microparticles to the fibers. A schematic illustration of the fiber coating process is provided in FIG. 1.

A 10-nm-thick gold particle layer was deposited on the grab samples by gold sputtering to characterize the microparticle deposited basalt fibers through SEM imaging. A scanning electron microscope operated at 10 kV was used for SEM imaging.

Composite Fabrication

Composite specimens having an approximate area of 120×6 mm² with two different thicknesses (˜2.65 mm and ˜0.64 mm) were fabricated by a filament winding process. First, the appropriate number of fiber tows were wound in a compression mold that has a fixed volume. The number of fiber layers were determined (i.e., 13 and 3 for thick and thin composites, respectively) based on the fiber diameter (˜13 μm) to achieve a ˜60 vol. % fiber content. Second, the fibers were infused with epoxy (resin:hardener=100:26.4 by weight). The high compressive force applied during the compression molding process squeezed out the excess epoxy from the mold, thereby maintaining the appropriate volume to bind with the fibers. Third, the composites were cured at 121° C. for ˜4 hours as recommended by the epoxy manufacturer. As mentioned earlier, a total of nine sets of specimens (one with only sized basalt fibers and the remaining with various BaTiO₃ content ranging from 0 wt. % to 4 wt. % in 0.5 wt. % increment) were fabricated for each thick and thin composite.

Sample Preparation

After curing, the composites were taken out from the mold and cut into the appropriate sizes (18×6×2.65 mm³ and ˜60×6×0.64 mm³) using a wet saw and dried at room temperature for ˜24 hours. Thick composites were used for mechanical and damage detection tests, and thin composites were used for electromechanical characterization. Six thick (a total of fifty-four) and three thin (a total of twenty-seven) specimens from each set were tested for mechanical and electromechanical studies. Additionally, thick specimens from each of the nine sets (a total of nine) were tested for damage detection validation.

The specimens used for electromechanical and damage detection tests were instrumented with surface electrodes for electrical measurements. 33 AWG wires were affixed on the top and bottom surfaces of the specimens. A two-part epoxy-based conductive paste was used for affixing the wires on the thin specimens. For the damage detection tests, the wires were attached using conductive copper tape, and polyimide tape was affixed on the copper electrodes to prevent any electrical short-circuiting with the metal test fixture during the experiments.

High-Voltage Poling

The electroded specimens were subjected to high-voltage poling to align the dipoles of the BaTiO₃ microparticles along the through-thickness direction of the specimens. The specimens were placed in a silicone oil bath and poled with a ˜9 kV DC electric potential for ˜4 hours by connecting them to a high-voltage DC power supply. The silicone oil bath prevents any electrical arcing during poling. After poling, the specimens were taken out from the silicone bath and thoroughly wiped and dried at room temperature for ˜24 hours before testing.

SEM Imaging Analysis

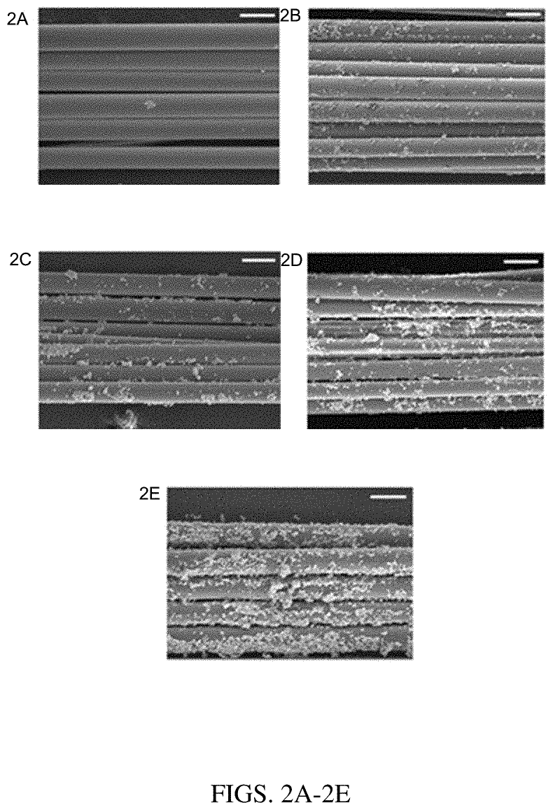

The dip-coating process was qualitatively assessed by SEM imaging. Five representative SEM images of the basalt fibers with different BaTiO₃ concentrations (i.e., 0, 1, 2, 3, and 4 wt. %) are shown in FIGS. 2A-2E, respectively. It is observed that the amount of deposited BaTiO₃ microparticles on the fiber surfaces increased with BaTiO₃ concentration. From 0 to 3.5 wt. %, the microparticle coating became more non-uniform. However, BaTiO₃ microparticles started agglomerating at higher concentrations, forming clusters on the fiber surfaces with more significant agglomerations appearing at the highest concentration of BaTiO₃, as observed in the SEM image in FIG. 2E. Such agglomerations can create stress concentrations sites that affect the bulk mechanical and electromechanical properties of the composite.

Mechanical Testing

Before testing the multifunctional properties of the composites, it is necessary to characterize their shear strength to ensure robust performance against flexural loadings and subsequent delaminations. Thick composite specimens (˜18×6×2.65 mm³) fabricated by a filament winding and compression molding process were subjected to three-point bending using a short beam shear configuration to quantify their apparent interlaminar shear strength (ILSS), which is based on a standard test method for apparent interlaminar shear strength of parallel fiber composites by short-beam method, American Society for Testing and Materials (ASTM D2344), Philadelphia, Pa. 1984. The short beam shear strength test method was adopted due to its simplicity and fidelity to test small specimens that reduce the volume of fibers needed for composite preparation. Although this data does not represent an absolute value of ILSS, the apparent short beam shear strength (F_{sbs}) obtained through ASTM D2377 is sufficient for studying the relative effect of BaTiO₃ microparticles on the composites' shear properties.

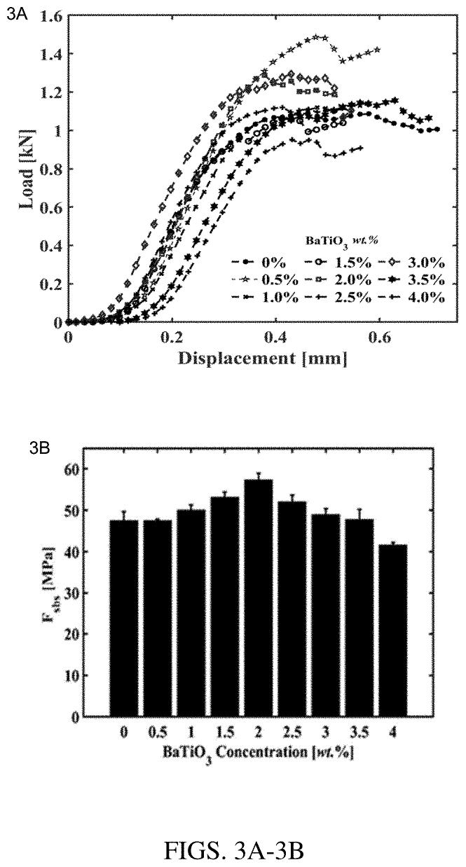

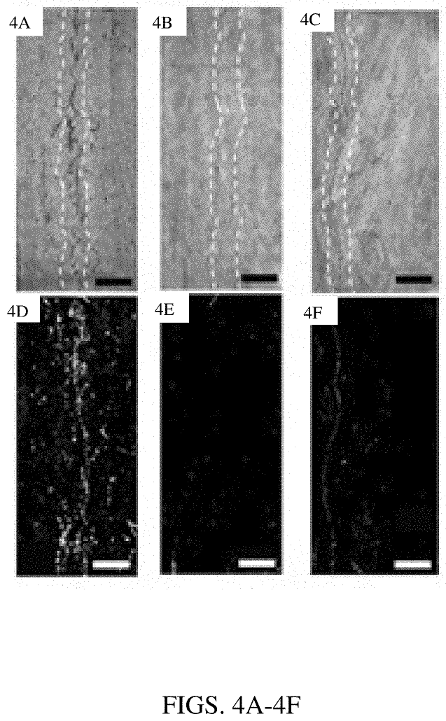

FIG. 3A shows the representative load-displacement graphs for all the tested specimens. It is observed that all load-displacement graphs exhibited a linear elastic deformation region, at least up to 0.7 kN. The initial non-linearities at low displacement were simply due to loading fixture positioning on the specimens' surfaces. The average F_{sbs} are summarized in FIG. 3B. F_{sbs} increased with increasing BaTiO₃ concentration, but after reaching an optimum loading of 2 wt. % BaTiO₃, the F_{sbs} experienced a gradual drop with further increasing BaTiO₃ concentration. Overall, FIG. 3B indicates that all the specimens with different BaTiO₃ contents exhibit better F_{sbs} as compared to the pristine composites, except the highest microparticle-loaded specimens (i.e., 4 wt. %), which suffered a ˜12% degradation in F_{sbs}. Among all the specimens, the 2 wt. % specimens exhibited a maximum increment (˜20%) in F_{sbs} as compared to the pristine composites.

It is hypothesized that such a trend was observed mainly due to the change in physical interactions between the fibers and the matrix caused by the introduction of BaTiO₃ microparticles at the fiber-matrix interfaces. For example, BaTiO₃ microparticles may offer better stress transfer between the fibers and the matrix, showing an enhanced F_{sbs} (e.g., A. Nassar et al., Nanoscience and Nanoengineering, 1, 89, 2013). As the BaTiO₃ microparticles are rigid compared to the epoxy matrix, they can absorb more energy and form tortuous pathways for crack propagation, contributing to superior F_{sbs}. On the other hand, the decrement observed in F_{sbs} at higher concentrations of BaTiO₃ could be attributed to BaTiO₃ microparticle agglomerations on the fiber surfaces that were seen in the SEM images (e.g., FIG. 2E). Such agglomerations may have functioned as a weak spot or stress concentration site for damage initiation. The reduced distances between the BaTiO₃ microparticles and their dense packing on the fiber surfaces may have encumbered the fiber matrix-interaction, thereby curbing the composites' shear performance, as seen in the case of 4 wt. % specimens.

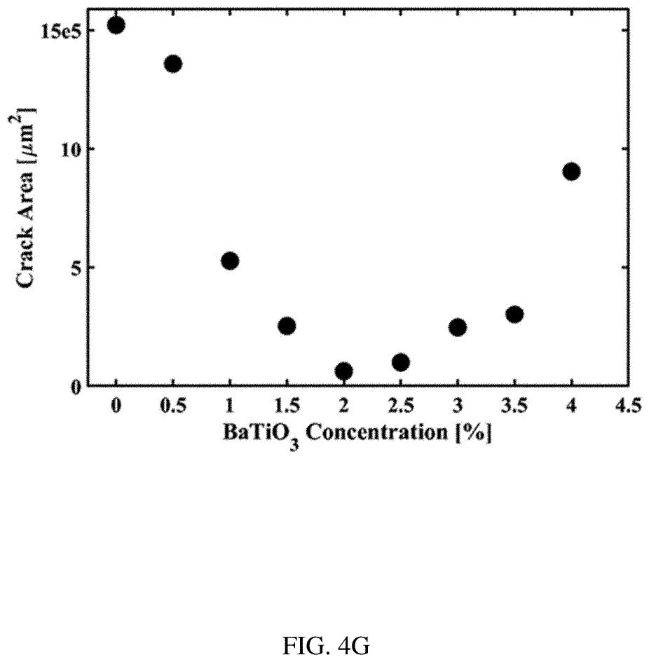

To further validate this hypothesis, the cross-sections of the tested specimens were examined with a digital optical microscope. It should be noted that the surfaces of the specimens were kept unpolished to avoid damaging the existing crack structure. Three representative images of the specimens (0, 2, and 4 wt. %) are shown in FIGS. 4A-4C. These images indicate that the crack area decreased from pristine to 2 wt. % microparticle containing specimens and then increased in the 2.5 wt. % to 4 wt. % specimens. For quantification, the crack sizes were evaluated through image analysis. First, the microscopy images of the composites were imported to the VHX image processing platform and converted to gray-scale. Second, image contrasts were enhanced using the histogram equalization method to distinguish the crack area from the background. Third, the enhanced gray-scale images were converted into binary black and white images (FIGS. 4D-4F), and all the pixels within the crack areas were selected. Finally, the crack areas were calculated by estimating the total areas corresponding to the selected image pixels. All the image contrasts were set to the same range to compare the crack areas observed in different specimens.

The results of the crack area for every BaTiO₃ concentration are graphically summarized in FIG. 4G. It is seen that pristine specimens had the largest crack area of ˜15×10⁵ μm². The crack area gradually decreased by more than 90% to a minimum of ˜1.5×10⁵ μm² for the 2% specimens and increased again to ˜9×10⁵ μm² in the 4 wt. % specimens. This result supports the above hypothesis and explains the observed trend in F_{sbs} (FIG. 3B). At a lower concentration (from pristine to 2 wt. %), BaTiO₃ microparticles facilitate a better interlocking between the fibers and matrix that offer a higher resistance to the crack propagation, and this results in a significant reduction in crack area. However, the fiber-matrix interactions were hindered at higher concentrations of BaTiO₃ microparticles (i.e., from 2.5 wt. % to 4 wt. % specimens) that experienced increasing crack area, which resulted in less profound increases in F_{sbs}. Nonetheless, these results demonstrate that incorporating BaTiO₃ microparticles by simply dip-coating the basalt fibers in water-based BaTiO₃ suspensions enhances F_{sbs} of the composites with an optimum range of 2 wt. % microparticle loading.

Electromechanical Characterization

One of the main objectives of this study is to utilize the ferroelectric behavior of BaTiO₃ to integrate passive self-sensing and energy-harvesting properties in the composites. Below the Curie temperature (121° C.) in tetragonal BaTiO₃ crystals, the Ti⁴⁺ ions are located away from the center and the O²⁻ are displaced from the face-centered positions, which produces a net dipole moment (K. Scharnowski, et al., IEEE Computer Graphics and Applications 2013, 33, 9). When mechanically stressed, the Ti⁴⁺ and O²⁻ ions move from their stable positions to generate electrical potential differences. However, the deposition process results in a random dispersion of the BaTiO₃ crystal dipole orientations resulting in no net orientation, so electrical poling is required to create a net dipole orientation to demonstrate a piezoelectric response in the bulk composite. In this study, ˜60×6×0.64 mm³ specimens were poled with a 9 kV electric potential. Such potential was selected to create an electric field of ˜14 kV/mm through the thickness of the specimen, which is assumed sufficient for an effective polarization of the BaTiO₃ microparticles in the fiber-reinforced composites (Gupta et al., Measurement Science and Technology, 32, 024010, 2020). The poled specimens were arranged in a cantilevered form with a 20 g tip mass and subjected to time-varying support excitations. The voltage responses obtained from the specimens were recorded for electromechanical characterization.

Before sensing and energy harvesting tests, the specimens' natural frequencies were estimated by exciting the beams with white-noise support excitations (peak amplitude=0.65 g, g=gravitational acceleration, frequency range=0-50 Hz). The measured tip mass accelerations were multiplied with a Hanning window and auto spectral densities were determined (20 averages, 50% overlap). It was found that the natural frequencies of all the specimens were in the range of 8-11 Hz. 10 Hz sinusoidal excitations were used in all the electromechanical tests to take advantage of increased beam deflection near the resonant frequency.

Passive Sensing

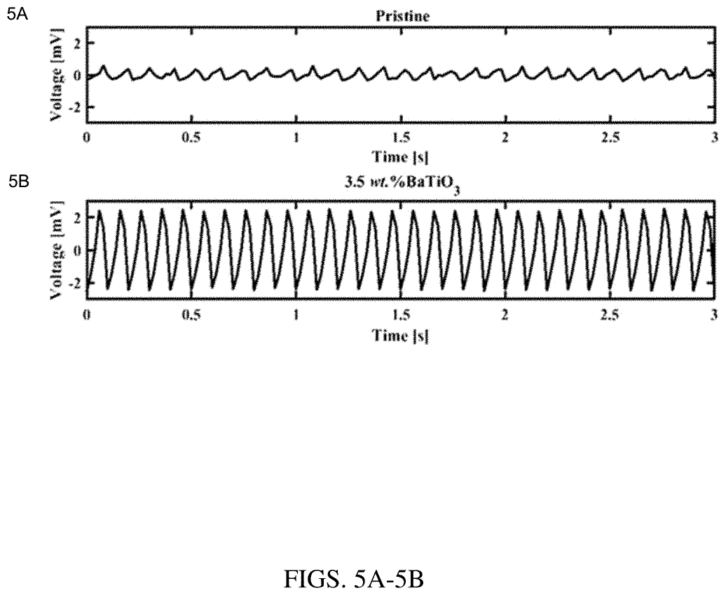

For sensing characterization, the cantilevered specimens were subjected to 10 Hz sinusoidal support excitations of various amplitudes (˜0.11 g, 0.24 g, 0.40 g, 0.54 g, and 0.65 g) while their electrical responses were recorded. The sampling frequency was set to 50 Hz, high enough to avoid aliasing in the recorded signals. Representative three-second voltage-time histories shown in FIGS. 5A and 5B (for pristine and 3.5 wt. % BaTiO₃-contained specimens, respectively) show that the output voltages obtained from all the specimens, except for the pristine composites, increased with the amplitude of the input excitations. This result is proof of the piezoelectric responses of the BaTiO₃-enhanced composites. Ideally, the pristine specimens should not produce any electricity in response to the dynamic stresses as they do not contain any piezoelectric particles. However, some electrical responses were obtained because of the system noise (FIG. 5A). As a consequence, the electrical responses for the pristine specimens have a poor signal-to-noise ratio compared to the other composites, and these responses are interpreted as system noise rather than true electrical responses from the composites. Therefore, the electromechanical responses from the pristine specimens were not analyzed for further characterizations.

The peak counts in the voltage-time histories shown in FIGS. 5A and 5B indicate the number of loading cycles experienced by the specimens. As they underwent forced vibrations of 10 Hz frequencies for three seconds, thirty peaks should be observed in their steady-state voltage-time histories. However, some failed to detect the number of loading cycles below certain amplitudes of the input accelerations. For instance, 0.5 wt. % specimens did not exhibit electrical signals corresponding to the vibrations below 0.24 g. Therefore, BaTiO₃-enhanced composites have limitations in sensing vibrations if they are below a threshold.

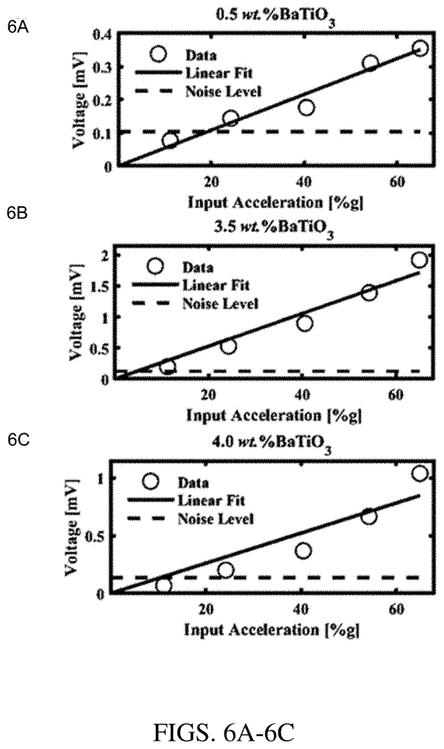

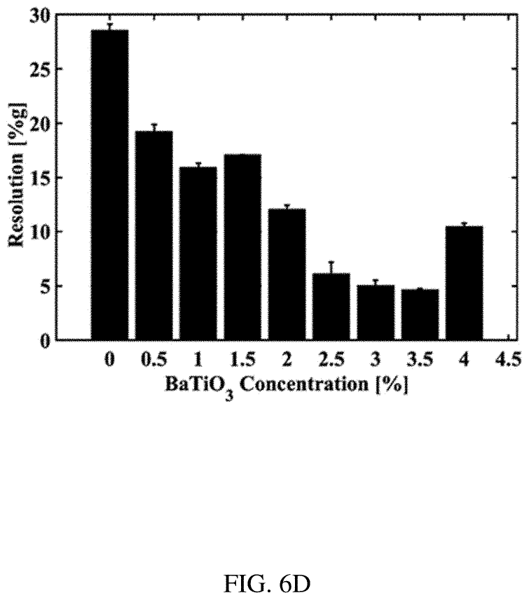

In order to quantify these limits, the resolutions of the BaTiO₃-enhanced composites were characterized. Resolution is the property of a sensor that specifies the smallest vibration which can be reliably measured. It is hypothesized that vibrations can be captured if the root-mean squares (RMS) of the response measurements are higher than the noise present in the systems. Noise level is defined as the RMS of voltage signals that were recorded from each specimen at their unstrained conditions (i.e., specimens at rest). First, the RMS of the output voltage signals were plotted as a function of the input excitations. Second, linear least-squares regression lines were fitted to these RMS values, as shown in FIGS. 6A-6C. Finally, the corresponding noise levels were overlaid. Here, the abscissa of the intersection of the noise level and the best-fit line is the effective resolution of the system (Gupta et al.).

The average resolutions of all nine sets of specimens are shown in FIG. 6D. Overall, a trend is observed where the resolution improved from ˜0.19 g (0.5 wt. % specimens) to ˜0.045 g (3.5 wt. % specimens) and then deteriorated to ˜0.10 g (4 wt. % specimens). As the resolution of the 0.5 wt. % specimen is larger than 0.11 g, it would not sense low-magnitude vibrations which are below its resolution. In fact, the poor performances of 1 wt. % and 1.5 wt. % specimens in response to ˜0.11 g or 0.24 g are also justified as their resolutions (˜0.16 g and ˜0.17 g, respectively) are close to the amplitude of these loadings.

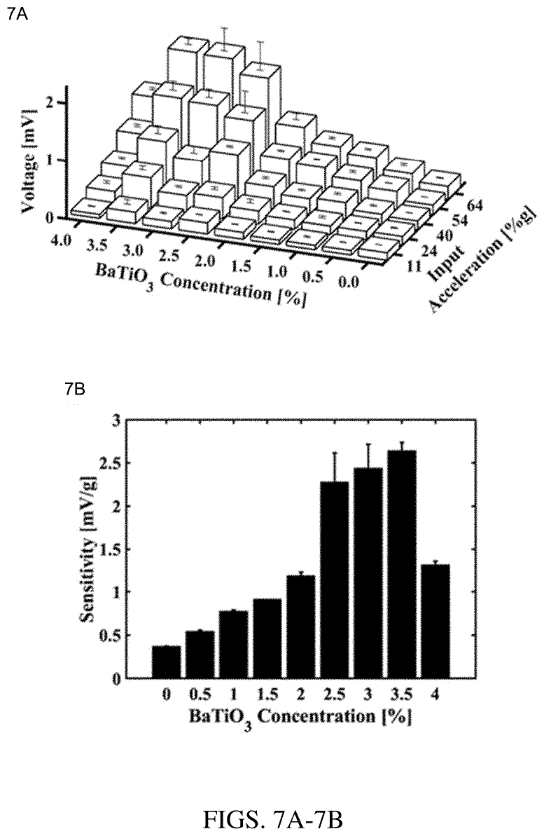

For further characterization, RMS values of the recorded voltage responses corresponding to various input excitations were plotted as a function of BaTiO₃ concentration, as shown in FIG. 7A. It is observed that the RMS values corresponding to the same acceleration state increased with BaTiO₃ concentration as exhibited by the 0.5 wt. % to 3.5 wt. % specimens. This result makes sense as more BaTiO₃ microparticles present in the composites offer more ferroelectric material to be stressed during dynamic loading to output magnified voltage responses than their lower concentration counterparts.

Additionally, the sensitivities of the specimens were estimated by calculating the slope of the least-squares linear fit lines of FIGS. 6A-6C as graphically outlined in FIG. 7B. Sensitivity implies the output voltage that can be obtained from a composite specimen for a unit change in input excitation. FIG. 7B shows that the sensitivity gradually increases from 0.5 wt. % to 3.5 wt. % specimens and a maximum was observed at 3.5 wt. % (˜2.6 mV/g) followed by a drop to ˜1.4 mV/g, as seen in the case of 4 wt. % specimens.

In general, these studies reveal that 3.5 wt. % composites have the highest sensitivity with the finest resolution among all the tested specimens with different BaTiO₃ contents. Also, increasing the microparticle concentration within the composites does not always enhance their sensing properties (i.e., resolution and sensitivity). In fact, the sensing properties of the 4 wt. % specimens were worse than the 3.5 wt. % specimens. Such performance could be a consequence of the large agglomerations of BaTiO₃ microparticles on the fiber surfaces that were previously observed in the SEM images (FIG. 2E). Hence, the concentrations of BaTiO₃ microparticles should be optimally set to attain the best passive sensing performances. Nevertheless, these results validate the ability of the dip-coating process to produce fibers coated with BaTiO₃ microparticles and their use in producing reinforced composites with passive self-sensing properties.

Energy Harvesting

Besides sensing, electrical signals (i.e., voltage) obtained from the dynamically excited BaTiO₃-enhanced composites can be leveraged for energy harvesting. This study aims to characterize the energy harvesting abilities of the composites. The cantilevered specimens were excited with a 10 Hz sinusoidal support excitation of an amplitude of 0.65 g. Here, the output voltages were measured across various resistances that were connected in parallel with the specimens.

The power generated by the composite was calculated using Equation 1, as follows:

$$Power = {I}_{L ( R M S )}^{2} {R}_{L} = {V}_{L ( R MS )}^{2} / {R}_{L}$$

where R_{L}, I_{L(RMS)}, and V_{L(RMS)} are the load resistance, RMS of the total current in the circuit, and the RMS of the voltage across the R_{L}, respectively. For comparison, the calculated output powers were normalized by the volume of individual specimens to estimate their power densities.

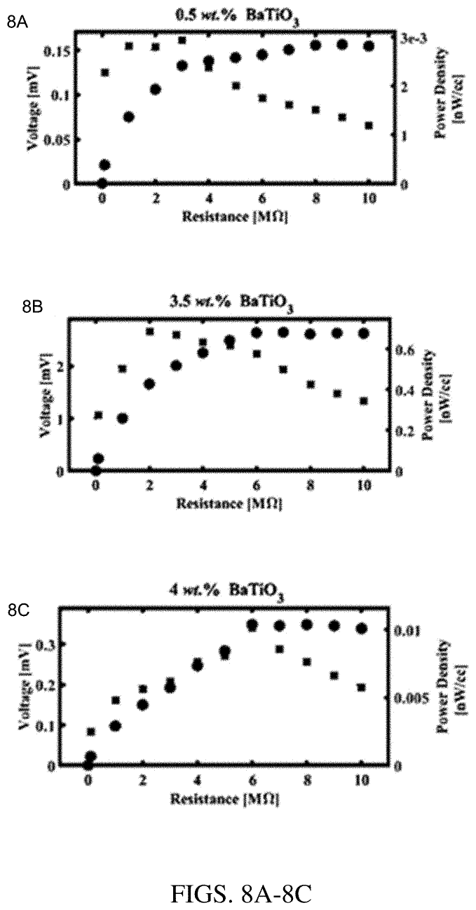

The RMS voltage output for 0.5 wt %, 3.5 wt %, and 4.0 wt % BaTiO₃, shown in FIGS. 8A-8C, respectively, rapidly increased, followed by saturation with increasing resistances, representing a peak power output at a matched impedance. The peak power density increased from ˜2.6×10⁻³ nW/cc (0.5 wt. % specimen) to ˜0.68 nW/cc (3.5 wt. % specimen) and then sharply decreased to 0.01 nW/cc (4 wt. % specimen). The average peak power densities and their standard deviations for all the tested specimens are tabulated in Table 1 below.

TABLE 1
BaTiO₃-enhanced composites' energy harvesting results.

| | |
|---|---|
| BaTiO₃ concentration | Maximum power density (nW/cc) |

| (wt. %) | Mean | Standard deviation |
|---|---|---|
| 0.5 | 0.0029 | 0.0029 |
| 1.0 | 0.0115 | 0.0039 |
| 1.5 | 0.1813 | 0.0684 |
| 2.0 | 0.0858 | 0.0028 |
| 2.5 | 0.4694 | 0.0911 |
| 3.0 | 0.4257 | 0.0100 |
| 3.5 | 0.6865 | 0.0256 |
| 4.0 | 0.0101 | 0.0011 |

Despite the relatively low power density of these composites compared to energy harvesters reported by researchers in the past (μW/cc range), the present research demonstrates the advantage of the proposed dip-coating method to integrate ferroelectric microparticles within the reinforced composites that can harvest energy from vibrations while exhibiting improvement in structural properties and damage detection capabilities, as further discussed below. The resulting material has the potential to eliminate the need for batteries for low power electronics, thereby reducing the complexity, cost, and extra weight to the structures.

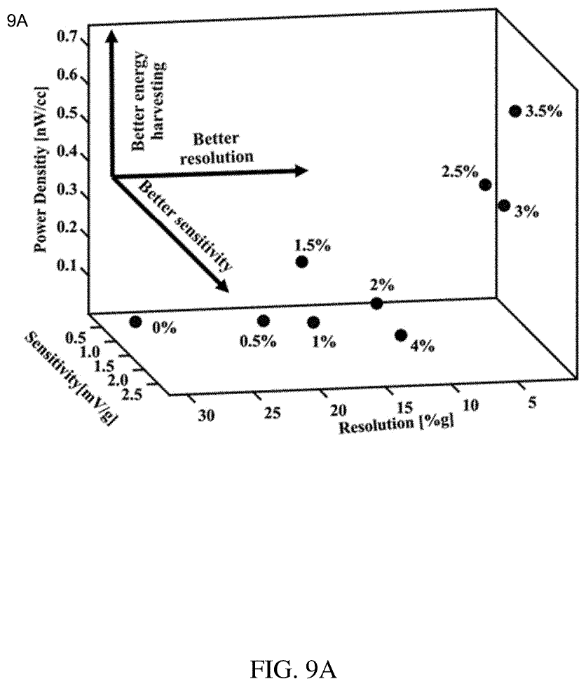

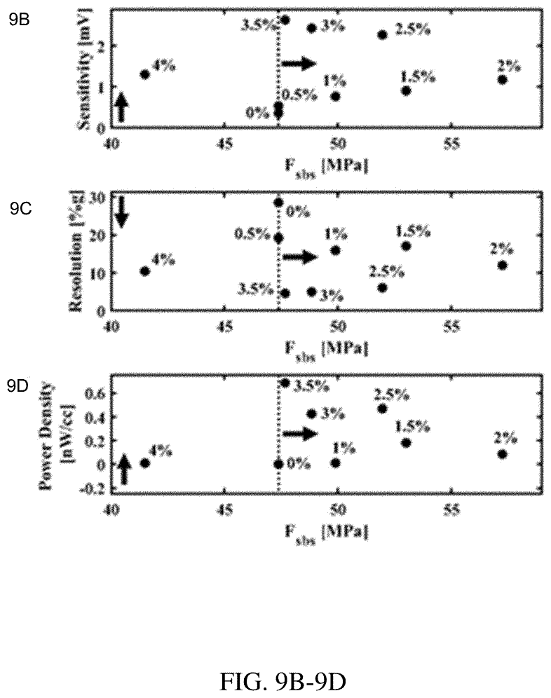

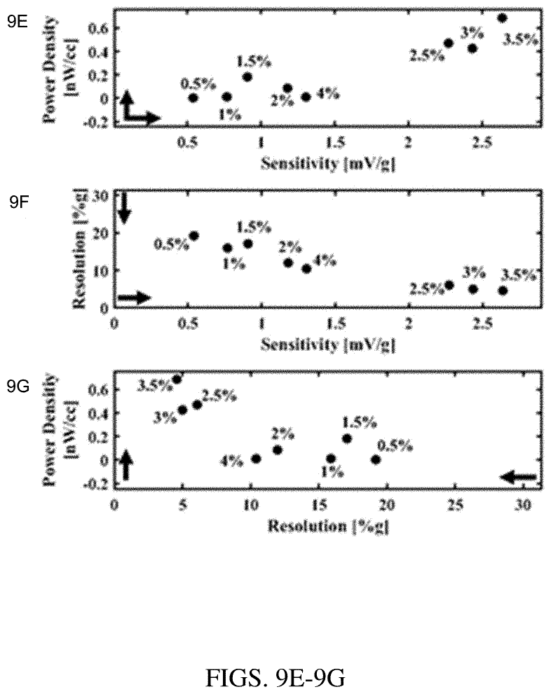

The mechanical and electromechanical test results are summarized in FIG. 9A and resolved in the six component figures (FIGS. 9B-9G) for a better understanding. The right-hand side of the dotted lines in FIGS. 9B-9G highlight the composites with better F_{sbs} along with the various electromechanical properties (e.g., resolution, sensitivity, and energy harvesting). While FIGS. 9E-9G indicate that the electromechanical properties of all BaTiO₃-enhanced composites improve with increasing BaTiO₃ concentration up to 3.5 wt. %, FIGS. 9B-9D demonstrate that they became superior in terms of F_{sbs} than the pristine counterparts except for the 4 wt. % specimens. Overall, FIGS. 9A-9G confirm that an optimum BaTiO₃ concentration should be maintained to attain the best mechanical and electromechanical properties of the reinforced composites.

In Situ Damage Detection

The last set of experiments aims to demonstrate the in situ damage detection capability of these BaTiO₃-enhanced composites. Damage in the composites can be initiated from a sub-surface matrix cracking or matrix-fiber debonding, which, if undetected, can result in a structural collapse. Therefore, it is critical to detect such damage at an early stage to permit corrective actions to be taken before catastrophic failure.

Instead of predicting the catastrophic failures, this study aims to capture the damage initiation in the composites when subjected to gradual transverse loading. Although piezoelectric responses should not be exhibited by the BaTiO₃-enhanced composites when subjected to quasi-static loading, stress waves generated due to the damage initiation will dynamically perturb the BaTiO₃ microparticles, thereby resulting in peaks in the voltage-time histories.

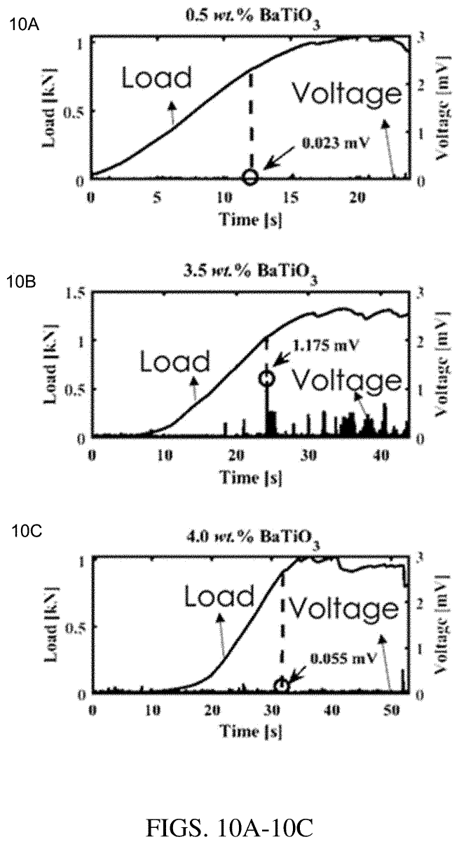

The short beam shear test method used during the ILSS characterization was utilized in this study. In the test, the electrical responses of the specimens were recorded when they were subjected to three-point bending, and the load and voltage-time histories were simultaneously recorded. During the ILSS tests, the load-displacement responses of the specimens were linear before 0.7 kN of loading, as found in FIG. 3A. Therefore, it can be inferred that any loading below this threshold would not damage the composites used in this study. In this study, the damage initiation is defined as the first observed inflections in the load vs. time plots after 0.7 kN. The voltages corresponding to the damage initiation points are identified and shown in FIG. 10.

It is observed that voltage outputs corresponding to damage initiations increased from 0.017 mV (pristine specimen) to 1.175 mV (3.5 wt. % specimen) and then decreased to 0.055 mV (4 wt. % specimen). In fact, clear peaks in voltage-time histories were observed in the cases of 2.5, 3, and 3.5 wt. % specimens, which demonstrates that the BaTiO₃-enhanced composites can identify damage initiation. Some other significant peaks were observed in the voltage time history plots prior to the identified damage initiations. It is assumed that these false readings occurred due to some inferiorities in the copper tape electrodes attached to that particular specimen. It should be noted that the output voltage from the 3.5 wt. % specimen during the damage initiation was the maximum among all the tested composites. Previously, it was found that 3.5 wt. % specimens exhibit the best sensitivity and resolution, which are the two required features for damage identification at a minute level. Although further studies are required for damage classification (e.g., matrix cracking, delamination, debonding, or fiber breakage), the above results demonstrate in situ damage detection without the need of an external power source.

### CONCLUSIONS

A roll-to-roll dip-coating process was used for depositing BaTiO₃ microparticles on basalt fiber surfaces to fabricate a multifunctional composite. Commercially available BaTiO₃ microparticles were integrated in reinforced composites without the need for chemical modification of the fiber surfaces. The process does not rely on toxic solvents or high concentrations of microparticles, therefore making it environmentally friendly and easy-to-use at the industrial scale.

The microparticle-coated fibers were directly used to manufacture the composites by a traditional filament winding method. Nine sets of composite specimens were manufactured with different BaTiO₃ contents. The BaTiO₃-enhanced composites exhibit passive sensing and energy harvesting properties along with an improved ILSS. First, the apparent ILSS was evaluated through short beam shear tests and a maximum ˜20% increment was observed in the 2 wt. % microparticles containing specimen compared to the pristine counterparts. Second, the passive sensing property of the composites was characterized by exciting them with dynamic support excitations. It was found that 3.5 wt. % microparticle-enhanced specimens exhibit the highest sensitivity of ˜2.65 mV/g with the best resolution of ˜0.045 g. Third, it was verified that the BaTiO₃-enhanced composites can also harvest energy from vibrations. In addition to the best sensing performance, 3.5 wt. % specimens demonstrated an exceptionally high energy harvesting ability of ˜0.67 nW/cc. The composites described herein may exhibit an energy harvesting ability of at least, for example, 0.3, 0.4, 0.5, 0.6, or 0.7 nW/cc. Therefore, a prudent selection of the BaTiO₃ concentration can result in a multifunctional composite with optimal mechanical and electromechanical properties. Finally, it has herein been shown that the BaTiO₃-enhanced composites successfully detected in situ sub-surface damage initiation. In this experiment, the 3.5 wt. % composites outperformed the other specimens by exhibiting the highest signal-to-noise ratio. This result demonstrated that a truly multifunctional composite was achieved that could perform passive sensing and energy harvesting while improving ILSS.

While there have been shown and described what are at present considered the preferred embodiments of the invention, those skilled in the art may make various changes and modifications which remain within the scope of the invention defined by the appended claims.

What is claimed is:

1. A composition comprising:
(i) an electrically non-conductive fiber having a surface; and
(ii) piezoelectric particles adhered to the surface of said electrically non-conductive fiber.

2. The composition of claim 1, wherein the coated fiber composition is embedded within a matrix to form a composite material.

3. The composition of claim 2, wherein the matrix is a polymer, ceramic, or glassy carbon matrix.

4. The composition of claim 2, wherein said piezoelectric particles are present in an amount of 0.1-10 wt % by total weight of the composite material.

5. The composition of claim 1, further comprising: (iii) a sizing agent coated over the piezoelectric particles and surface of said electrically non-conductive fiber.

6. The composition of claim 5, wherein said sizing agent is an epoxy sizing agent.

7. The composition of claim 1, wherein said electrically non-conductive fiber has a composition selected from the group consisting of basalt, glass, polymer, and ceramic.

8. The composition of claim 1, wherein said electrically non-conductive fiber has a basalt composition.

9. The composition of claim 1, wherein said piezoelectric particles have a particle size of at least 100 nm.

10. The composition of claim 1, wherein said piezoelectric particles have a perovskite or halide perovskite composition.

11. The composition of claim 10, wherein said piezoelectric particles have a barium titanate, lead zirconate titanate, potassium niobate, sodium potassium niobate, or bismuth ferrite composition.

12. The composition of claim 1, wherein said piezoelectric particles have a zinc oxide composition.

13. A method for producing a fiber composition, the method comprising:
(a) coating a fiber having a surface with a liquid suspension comprising piezoelectric particles suspended in a solvent; and
(b) removing the solvent to result in said piezoelectric particles adhered to the surface of the fiber.

14. The method of claim 13, further comprising: (c1) thermal treating the fiber coated with piezoelectric particles as produced in step (b) to adhere the piezoelectric particles more strongly to the surface of the fiber.

15. The method of claim 13, further comprising: (c2) coating the fiber coated with piezoelectric particles as produced in step (b) with a sizing agent to adhere the piezoelectric particles more strongly to the surface of the fiber.

16. The method of claim 15, wherein said sizing agent is an epoxy sizing agent.

17. The method of claim 13, wherein said fiber is electrically conductive.

18. The method of claim 13, wherein said fiber is electrically non-conductive.

19. The method of claim 18, wherein said electrically non-conductive fiber has a composition selected from the group consisting of basalt, glass, polymer, and ceramic.

20. The method of claim 18, wherein said electrically non-conductive fiber has a basalt composition.

21. The method of claim 13, wherein said piezoelectric particles have a perovskite or halide perovskite composition.

22. The method of claim 21, wherein said piezoelectric particles have a barium titanate, lead zirconate titanate, potassium niobate, sodium potassium niobate, or bismuth ferrite composition.

23. The method of claim 13, wherein said piezoelectric particles have a zinc oxide composition.

24. The method of claim 13, wherein said liquid suspension excludes a surfactant.

25. The method of claim 13, wherein said solvent comprises at least 50 vol % water.

26. A method of detecting formation of defects in a material in which piezoelectric particles are incorporated, the method comprising reading the baseline voltage between two electrodes in electrical communication placed on the surface of the material and monitoring the voltage over time, wherein a voltage spike indicates formation of a defect.

27. The method of claim 26, wherein the defect is a crack.

28. The method of claim 26, wherein the piezoelectric particles are adhered to fibers also incorporated into the material.

29. A method of generating electrical energy from ambient vibration, the method comprising placing a material in which piezoelectric particles are incorporated in a location prone to ambient vibration, and attaching electrodes in electrical communication on the surface of the material to result in conversion of said ambient vibration into electrical energy.

30. The method of claim 29, wherein the piezoelectric particles are adhered to fibers also incorporated into the material.
